(19) United States
(12) Patent Application Publication
(10) Pub. No.: US 2009/0159426 A1
(43) Pub. Date: Jun. 25, 2009

(54) Electrostatic Separator with Multiple Horizontal Electrodes

(75) Inventor: James C.T. Chen, Houston, TX (US)

Correspondence Address: CAMERON INTERNATIONAL CORPORATION, P.O. BOX 1212, HOUSTON, TX, 77251-1212, US

(73) Assignee: CAMERON INTERNATIONAL CORPORATION, Houston, TX (US)

(21) Appl. No.: 12/331,565

(22) Filed: Dec. 10, 2008

Related U.S. Application Data
(60) Provisional application No. 61/015,402, filed on Dec. 20, 2007.

(51) Int. Cl. C10G 32/02; B01J 19/08

(52) U.S. Cl. 204/167; 422/186.04; 204/164

(57) ABSTRACT

An electrostatic dehydrator or separator having at least two generally horizontal electrodes will function as a separator for water and oil, and also for gas, water and oil. Gas/liquid separation occurs in the front section of the vessel. Oil/water separation takes place in a subsequent section of the vessel which may have two or three independent generally horizontal electrodes or grids spaced at different distances above the generally horizontal oil/water interface. The two or three independent electrodes or grids will each have their own transformer. The higher grid(s) will continue to operate even if the lower grid(s) short out.

### CROSS-REFERENCE TO RELATED APPLICATION

This application claims the benefit of U.S. Provisional Application Ser. No. 61/015,402 filed Dec. 20, 2007.

### BACKGROUND OF THE INVENTION

The present invention relates to methods and apparatus for electrostatic separators and dehydrators, and particularly relates, in one non-limiting embodiment, to electrostatic separators that have more than one electrode or grid.

It is well known that petroleum as it is recovered from an underground formation must be initially treated so as to separate and remove entrained gas and emulsified brine or water, to prepare the oil for transport in a pipeline and to remove the gas and water which do not need to be transported, and which would be costly to transport in any event. Various techniques and processes have been previously used in order to minimize treatment time and avoid high-energy consumption.

In particular, U.S. Pat. No. 4,329,159 (“Energy Saving Heavy Crude Oil Emulsion Treating Method and Apparatus for Use Therewith”) describes a method and apparatus comprising an elongated horizontal cylindrical tank, divided by internal partitions, into compartments through which the petroleum will sequentially flow. Burner-fired heaters are included in an upstream heater section for heating the emulsion to a desired temperature, during which most of the entrained gas and some of the brine separate from the emulsion. The partially de-emulsified brine then flows into a coalescing section, encountering a series of baffles adapted to encourage even flow of fluids and to avoid the formation of flow channels within the fluid body. Additionally, high-potential electrostatic fields are applied by energizing vertically oriented grids with high voltage potential. The grids are adjacent to each grounded baffle, which creates the fields between each grid and grounded baffle. The grids are electrically connected to the same, single transformer. The resultant electrostatic fields coalesce the droplets of brine remaining in the oil into drops of sufficient size and weight that they flow downwardly by gravity to the bottom of the coalescing section for removal. Oil substantially free of brine then flows over a wall into a reservoir where the brine-free oil may be intermittently or continuously discharged, without affecting the liquid level in the treater.

Electrostatic coalescence such as that described above has been well known for many years. For instance, older U.S. Pat. No. 3,207,686 discloses an electric dehydrator having horizontally oriented upper and lower foraminous electrodes which define a main treating space between the electrodes and an auxiliary treating space between the lower electrode and the body of separated water. The electrodes are each a sheet of metallic screen. The upper electrode is maintained at ground potential and the lower electrode is energized by a high voltage transformer.

Conventional electrostatic coalescers with a horizontally oriented electrode may also suffer difficulties if the oil/water interface, or the water level, rises too high and contacts the electrode, shorting it out, and causing the coalescer to cease operating, which disrupts downstream flow and processing. This can be a more particular concern for offshore platforms than for land-based operations, especially for floating platforms subject to the motion of the seas. Many electrostatic coalescers have horizontally oriented electrodes, but some have multiple vertically oriented electrodes. However, again if the bottom edges of these vertically oriented electrodes are contacted by the water, they will short out and the electrostatic field will no longer function.

Vetco Aibel markets a Vessel Internal Electrostatic Coalescer (VIEC) and a Low Water Content Coalescer (LOWACC). Unfortunately, both of these commercial systems suffer from deposit problems on the electrodes, which consist of horizontally oriented honey-comb structures. The solids contained in the crude will drop off and be deposited on the horizontal sections of the structure. These solids are suspended solids and clay solids within the oil. These deposits are problematic because they tend to cause shorts as well.

It would be desirable if methods and apparatus were devised that could easily coalesce water droplets, but which is more accepting of variable water levels.

### BRIEF SUMMARY OF THE INVENTION

There is provided, in one non-restrictive form, an electrostatic separator that involves a separation vessel having a mixture inlet and a horizontal axis. The separation vessel also has at least two horizontal electrodes oriented generally parallel to the horizontal axis, where the first horizontal electrode is spaced a first distance above the horizontal axis and the second horizontal electrode is spaced a second distance above the horizontal axis. The second distance is greater than the first distance. A separate transformer is electrically connected to each horizontal electrode. An oil outlet is present in an upper portion of the separation vessel, and a water outlet is present in a lower portion of the separation vessel.

There is also provided, in another non-limiting embodiment, an electrostatic separator that includes a separation vessel comprising a mixture inlet through which a mixture of at least oil and water enters the vessel. The separation vessel may contain a volume of oil over a volume of water. The volumes are roughly separated by a generally horizontal oil/water interface. The vessel has at least two horizontal electrodes oriented generally parallel to the horizontal oil/water interface. The first horizontal electrode is spaced a first distance above the horizontal oil/water interface and a second horizontal electrode is spaced a second distance above the horizontal oil/water interface. The second distance is greater than the first distance, so that the two electrodes are at different heights above the oil/water interface. A separate transformer is electrically connected to each horizontal electrode. An oil outlet is present in an upper portion of the separation vessel to withdraw oil from the vessel, and a water outlet is present in a lower portion of the separation vessel for withdrawing or removing water from the vessel. The use of at least two generally horizontal electrodes permits the coalescer to operate even if the oil/water interface rises sufficiently to contact and short out the lower electrode. The high voltage field generated by the upper electrode is still operative and allows the coalescer to keep operating. There can be at least three separate horizontal electrodes in some non-limiting embodiments, each with its own transformer.

In another non-restrictive example, there is provided a method for separating oil and water that involves introducing a mixture of oil and water into a separation vessel through a mixture inlet. The mixture of oil and water is permitted to separate into a volume of oil over a volume of water separated by a generally horizontal oil/water interface. At least a portion of the oil volume is subjected to an electrostatic field generated by at least two horizontal electrodes oriented generally parallel to the horizontal oil/water interface. The first horizontal electrode is spaced a first distance above the horizontal oil/water interface, and a second horizontal electrode is spaced a second distance above the horizontal oil/water interface, where the second distance is greater than the first distance. A separate transformer is electrically and independently connected to each horizontal electrode. Water droplets coalesce via the electrostatic field and drop via gravity from the oil volume into the water volume in a lower portion of the vessel and the oil-free or substantially oil-free water removed from the separation vessel through a water outlet. Oil is removed from the separation vessel through an oil outlet.

### BRIEF DESCRIPTION OF THE DRAWING

FIG. 1 is a schematic illustration of a three-phase separator showing one non-limiting embodiment of the separator apparatus herein.

It will be appreciated that the Figure is a schematic illustration that is not to scale or proportion, and, as such, some of the important parts of the invention may be exaggerated for illustration.

### DETAILED DESCRIPTION OF THE INVENTION

The three-phase electrostatic separator herein will function as a separator for gas, water and oil. Gas/liquid separation will occur in the front section of the vessel by conventional technology. Separation of the liquids of oil and water will take place in a subsequent or end section, which may contain up to three separate transformers each independently connected to three separate and unconnected grids/electrodes installed in the vessel in a horizontal orientation. It will be understood that the term “water” herein will encompass brines typically encountered in these mixtures and separations thereof.

In oil field production processes, conventional separation equipment of gas, oil, and water is conventionally conducted in a three-phase separator followed by a dehydrator. This equipment requires a considerable amount of space, and as is well known, space is at a premium on an offshore oil platform. The separation vessel herein combines the processes into one vessel, a vessel which can withstand and operate under conditions of motion where a volatile or rising water level may short out a high voltage electrode within the electrostatic portion of the separator. However, because more than one independent electrode is used, if a lower electrode is temporarily shorted out, an upper high voltage electrode continues to function so that the separator remains operational.

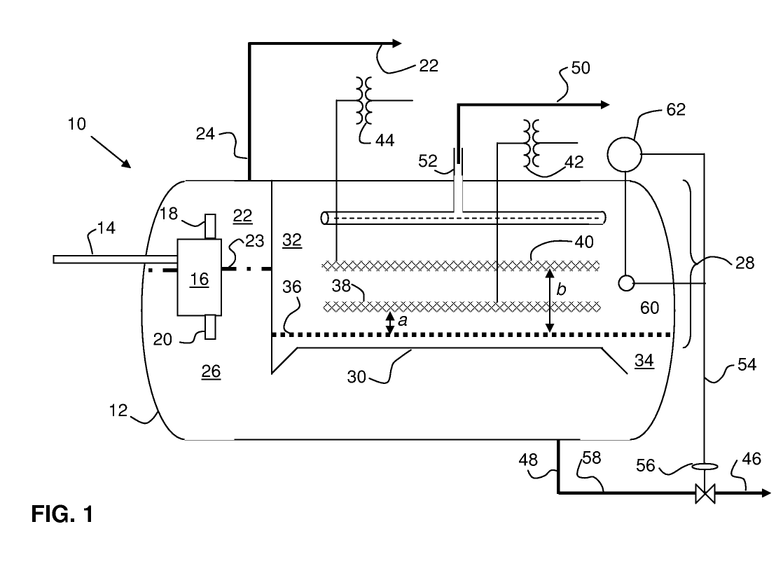

Shown in FIG. 1 is one non-limiting embodiment as a three-phase electrostatic separator 10 that includes a separation vessel 12 having a mixture inlet 14 for receiving a mixture of gas, water and oil. This mixture goes to conventional gas/liquid inlet separator 16, having a gas outlet 18 and a liquid outlet 20 for discharging the oil/water mixture 26. Separated gas 22 from gas outlet 18 above the interface 23 is removed via separator vessel gas outlet 24.

The oil and water mixture 26 travels downstream to subsequent or end oil/water separation (electrostatic) section 28 that is separated by baffle 30. Baffle 30 may be grounded to help establish the high voltage electrostatic field in section 28. A volume of oil 32 is separated by a volume of water 34 roughly by generally horizontal oil/water interface 36. The volume of oil 32 generally separates from volume of waster of its own accord in a preliminary separation prior to and/or simultaneously with subjecting at least a portion of the volume of oil 32 an electrostatic field to separate more water out of the oil. Oil/water interface 36 is noted as “generally” horizontal because if electrostatic separator 10 is mounted on a floating oil platform, with the shifting seas and motion of the platform, oil/water interface may temporarily not be horizontal. If of cylindrical shape, the three phase electrostatic separator 10 may be understood to have a generally horizontal central axis (not shown, but easily imagined); if separator 10 is of another shape, it may be understood to lie in or be positioned in a generally horizontal plane. The volume of oil 32 is substantially oil meaning that water droplets may be dispersed therethrough as a discontinuous phase. These water droplets are what are coalesced by the electrostatic field. The volume of water 34 may have oil droplets dispersed therein (again a phase internal to the water), but these droplets, being less dense than water, generally rise and coalesce with the volume of oil 32.

Oil/water separation (electrostatic) section 28 contains at least two horizontal electrodes, first (lower) horizontal high voltage electrode 38 and second (upper) horizontal high voltage electrode 40. The electrodes 38 and 40 are oriented generally parallel to the generally horizontal oil/water interface 36. It will be appreciated that since oil/water interface 36 is not always horizontal to separation vessel 12 for reasons stated above, electrodes 38 and 40, while parallel to the horizontal axis of vessel 12, will not always be parallel to oil/water interface 36 which may be shifting, tilting, rising or falling. First (lower) horizontal electrode 38 is spaced from the oil/water interface 36 a first distance a, while second (upper) horizontal electrode 40 is spaced from the oil/water interface 36 a second distance b, while the second distance b is greater than a. Alternatively, the first (lower) horizontal electrode 38 may be spaced above the horizontal central axis of separator 10 a first distance, while the second (upper) horizontal electrode 40 is spaced above the horizontal axis of separator 10 a second distance, again where the first and second distances are different from each other.

Without being limited to any particular embodiment, but to give some sense of scale, in one non-restrictive version a typical spacing between the electrodes or grids 38 and 40 may be between about 8 to 10 inches (about 20 to 25 cm). It is also expected that the voltage applied to each of the electrodes or grids 38 and 40 (or more, if used) is the same voltage, although it could be easily imagined that the voltage could be varied between the electrodes or grids for some purpose.

The electrodes 38 and 40 may be conventionally shaped electrode grids, or in one non-limiting embodiment may be cylindrically shaped rods with a round cross-section, arranged in a convenient planar pattern, so that they are less likely to collect undesirable deposits. The electrodes 38 and 40 may be of the same or different design or configuration compared to each other. Further, the electrodes 38 and 40 may be oriented higher in the separation vessel 12 than is conventionally designed. In one non-limiting embodiment, the lower or bottom electrode 38 may be typically located at or near the center of the vessel 12. The upper electrode 40 may be located about 10 to 12 inches (about 25 to about 30 cm) above the lower or bottom electrode 38. A third electrode, if present would be located about 10 to 12 inches (about 25 to about 30 cm) above the electrode 40. Again, these dimensions are merely illustrative and do not limit the embodiments described herein. Each electrode 38 and 40 is independently electrically connected to its own high voltage transformer, first transformer 42, second transformer 44 respectively. Thus, if oil/water interface 36 rises sufficiently for the water 34 to contact lower electrode 38 and short it out (distance a is reduced to zero), upper electrode 40 will continue to function to generate the high voltage field to encourage water droplets in body of oil or region 32 to coalesce and fall generally vertically through vessel 32 to be removed as separated water 46 through water outlet 48. Separated oil 50 is removed via oil outlet 52. It will also be understood that once the oil/water interface 36 drops or falls below the level of the lower electrode 38 and water no longer contacts it that the electrode function, and the high voltage field, will be restored.

Also within separator vessel 12 is an oil/water interface level control system, schematically illustrated at 54, which may be any conventional mechanical, electrical or electrical/mechanical or electronic/mechanical system that controls valve 56 in water line 58 so that oil/water interface 36 is positioned no higher than between lower electrode 38 and upper electrode 40 to avoid and prevent both electrodes 38 and 40 from undesirably shorting out. Oil/water interface level control system 54 will typically have a conventional mechanical, electrical and/or electronic interface level detector schematically illustrated at 60 to detect where interface 36 is, and conventional mechanical, electrical and/or electronic logical circuitry 62 to determine whether and how valve 56 should be controlled.

It will be appreciated that the apparatus herein is not limited to an electrostatic separator 10 having only a lower electrode 38 and upper electrode 40, but that there may be more electrodes present, including a third electrode independently electrically connected to a third transformer (not shown, but easily understood). Such a third electrode and transformer would provide increased operational versatility for the separator 10.

It is expected that the oil content in the effluent water 48 will be reduced with this apparatus and method, since the water retention in the separation vessel 12 is expected to be longer than is typical for electrostatic coalescers. In one non-limiting embodiment, the retention time may be about 30% longer than in a conventional electrostatic coalescer. It is also anticipated that an electrostatic separator 10 may be constructed without a gas/liquid inlet separator 16 if it is only necessary to separate oil and water.

In the foregoing specification, the invention has been described with reference to specific embodiments thereof, and is expected to be effective in providing methods and apparatus for separating mixed oil and water streams more efficiently, as well as mixed gas, oil and water streams. However, it will be evident that various modifications and changes can be made thereto without departing from the broader spirit or scope of the invention as set forth in the appended claims. Accordingly, the specification is to be regarded in an illustrative rather than a restrictive sense. For example, the separation vessel may be changed or optimized from that illustrated and described, and even though certain additional features were not specifically identified or tried in a particular system, would be anticipated to be within the scope of this invention. For instance, the use of an oil/water interface level control system other than those described would be expected to find utility and be encompassed by the appended claims.

Different mixed oil and water streams other than those described herein may nevertheless be treated and handled in other non-restrictive embodiments adapted by one having ordinary skill in the art for those streams. In another non-limiting example, the oil and water mixed stream may not contain gas and thus an inlet separator 16 may not be necessary. Such an example may be where a two phase separator is installed ahead of an electrostatic dehydration on a Floating Production, Storage and Offloading (FPSO) vessel where space is critical. The separator may be sized much smaller due to the advantages provided allowing a much higher basic sediment and water (BS&W) (primarily water) in the crude as feed to the dehydrator.

The present invention may suitably comprise, consist or consist essentially of the elements disclosed and may be practiced in the absence of an element not disclosed.

The words “comprising” and “comprises” as used throughout the claims is to interpreted “including but not limited to”.

What is claimed is:

1. An electrostatic separator comprising:
a separation vessel comprising a mixture inlet and a horizontal axis;
at least two horizontal electrodes oriented generally parallel to the horizontal axis, where a first horizontal electrode is spaced a first distance above the horizontal axis and a second horizontal electrode is spaced a second distance above the horizontal axis, where the second distance is greater than the first distance;
a separate transformer electrically connected to each horizontal electrode;
an oil outlet in an upper portion of the separation vessel; and
a water outlet in a lower portion of the separation vessel.

2. The electrostatic separator of claim 1 further comprising an inlet separator between the mixture separator and the volume of oil over the volume of water, the inlet separator comprising an outlet for the oil and water and a separate gas outlet.

3. The electrostatic separator of claim 1 where the electrodes are selected from a group of shapes consisting of a cylindrical rod, a grid, and combinations thereof.

4. The electrostatic separator of claim 1 further comprising a third horizontal electrode oriented generally parallel to the horizontal oil/water interface spaced a third distance therefrom different from the first distance and second distance.

5. An electrostatic separator adapted to hold a volume of oil over a volume of water within the separation vessel, the volumes separated by a generally horizontal oil/water interface, the separator comprising:
a separation vessel comprising a mixture inlet;
at least two horizontal electrodes oriented generally parallel to the horizontal oil/water interface, where a first horizontal electrode is spaced a first distance above the horizontal oil/water interface and a second horizontal electrode is spaced a second distance above the horizontal oil/water interface, where the second distance is greater than the first distance;
a separate transformer electrically connected to each horizontal electrode;
an oil outlet in an upper portion of the separation vessel; and
a water outlet in a lower portion of the separation vessel.

6. The electrostatic separator of claim 5 further comprising a horizontal oil/water interface level controller beneath the second horizontal electrode grid.

7. The electrostatic separator of claim 5 further comprising an inlet separator between the mixture inlet and the volume of oil over the volume of water, the inlet separator comprising an outlet for the oil and water and a separate gas outlet.

8. The electrostatic separator of claim 5 where the electrodes are selected from a group of shapes consisting of a cylindrical rod, a grid and combinations thereof.

9. The electrostatic separator of claim 5 further comprising a third horizontal electrode oriented generally parallel to the horizontal oil/water interface spaced a third distance therefrom different from the first distance and second distance.

10. An electrostatic separator comprising:
a separation vessel comprising a mixture inlet;
a volume of oil over a volume of water within the separation vessel, the volumes separated by a generally horizontal oil/water interface;
at least two horizontal cylindrical rod electrodes oriented generally parallel to the horizontal oil/water interface, where a first horizontal electrode is spaced a first distance above the horizontal oil/water interface and a second horizontal electrode is spaced a second distance above the horizontal oil/water interface, where the second distance is greater than the first distance;
a separate transformer electrically connected to each horizontal electrode;
an oil outlet in an upper portion of the separation vessel;
a water outlet in a lower portion of the separation vessel; and
a horizontal oil/water interface level controller beneath the second horizontal electrode grid.

11. The electrostatic separator of claim 10 further comprising an inlet separator between the mixture inlet and the volume of oil over the volume of water, the inlet separator comprising an outlet for the oil and water and a separate gas outlet.

12. The electrostatic separator of claim 10 further comprising a third horizontal electrode oriented generally parallel to the horizontal oil/water interface spaced a third distance therefrom different from the first distance and second distance.

13. A method for separating oil and water comprising:
introducing a mixture of oil and water into a separation vessel through a mixture inlet;
permitting the oil and water to separate into a volume of oil over a body of water separated by a generally horizontal oil/water interface;
subjecting at least a portion of the volume of oil above the generally horizontal oil/water interface, to an electrostatic field where the electrostatic field is generated by at least two horizontal electrodes oriented generally parallel to the horizontal oil/water interface, where a first horizontal electrode is spaced a first distance above the horizontal oil/water interface and a second horizontal electrode is spaced a second distance above the horizontal oil/water interface, where the second distance is greater than the first distance, and where a separate transformer is electrically connected to each horizontal electrode;
coalescing water droplets via the electrostatic field;
removing oil from the separation vessel through an oil outlet; and
removing water from the separation vessel through a water outlet.

14. The method of claim 13 further comprising controlling the level of the generally horizontal oil/water interface with an interface level controller located beneath the second horizontal electrode.

15. The method of claim 13 further comprising:
introducing a mixture of oil, water and gas into the separation vessel through the mixture inlet into an inlet separator between the mixture inlet and the horizontal electrodes;
separating the gas from the mixture of oil and water; and
removing the gas from a separate gas outlet.

16. The method of claim 13 where the electrodes are selected from a group of shapes consisting of a cylindrical rod, a grid, and combinations thereof.

17. The method of claim 13 where the separation vessel further comprises a third horizontal electrode oriented generally parallel to the horizontal oil/water interface spaced a third distance therefrom different from the first distance and second distance.
